(19) United States
(12) Patent Application Publication
(10) Pub. No.: US 2016/0133064 A1
(43) Pub. Date: May 12, 2016

(54) METHOD AND DEVICE FOR DETERMINING WHETHER AN ERROR CONDITION IS PRESENT IN A MOTOR VEHICLE

(71) Applicant: Robert Bosch GmbH, Stuttgart (DE)

(72) Inventors: Isidro Corral Patino, Stuttgart (DE); Evgeniya Ballmann, Stuttgart (DE); Thomas Mauer, Schwieberdingen (DE); Bernd Mueller, Leonberg (DE); Andreas Grimm, Tiefenbronn-Muehlhausen (DE); Simon Hufnagel, Ludwigsburg (DE); Thomas Hartgen, Ludwigsburg (DE)

(21) Appl. No.: 14/936,219

(22) Filed: Nov. 9, 2015

(30) Foreign Application Priority Data
Nov. 11, 2014 (DE) 10 2014 223 004.7

(51) Int. Cl. G07C 5/02; G07C 5/08

(52) U.S. Cl. CPC G07C 5/02; G07C 5/08

(57) ABSTRACT

A method for determining whether an error condition is present in a motor vehicle, a discrete state in which the motor vehicle is momentarily situated being ascertained with the aid of a state machine, monitoring functions for ascertaining whether an error condition is present being carried out or not as a function of the ascertained discrete state.

### RELATED APPLICATION INFORMATION

The present application claims priority to and the benefit of German patent application no. 10 2014 223 004.7, which was filed in Germany on Nov. 11, 2014, the disclosure of which is incorporated herein by reference.

### FIELD OF THE INVENTION

The present invention relates to a method for determining whether an error condition is present in a motor vehicle. The present invention also relates to a device, in particular a control unit, which is configured to carry out this method.

### BACKGROUND INFORMATION

A method for controlling the driving power of a vehicle is discussed in DE 44 38 714 A1, in which a microcomputer is provided for carrying out control functions and monitoring functions. In this microcomputer at least two mutually independent planes are specified, a first plane carrying out the control function and a second plane carrying out the monitoring function.

### SUMMARY OF THE INVENTION

It is possible to implement a continuous monitoring of the torque by inferring an actually setpoint torque in an internal combustion engine from the fuel injection timing with the aid of a recalculation, and comparing this with a torque input of the driver derived from the position of the accelerator pedal. Such a concept is complicated, however, since a change in the control software of the drive train or in the application entails a change in the monitoring software.

A method for determining whether or not an error condition is present in a motor vehicle, in particular in a control of a drive train of the motor vehicle, this determination being carried out with the aid of monitoring functions, which determine in each case for specific error conditions whether such an error condition is present or not, and these monitoring functions being carried out or not depending on the condition in which the motor vehicle is situated, has the advantage that it is particularly resource-efficient. For example, it may be provided that the monitoring functions are carried out only if the violation of the safety objective which it monitors is even possible.

Moreover, this method has additional advantages, in particular in vehicles having the drives, such as, electric drives or a hybrid drive train, since multiple safety objectives may be covered. For example, it is possible to take the safety objectives “avoid unintended delay” and “avoid unintended yawing moment” simultaneously into account.

This means that a flexible on and off switching of the monitoring functions is provided as a function of whether they are relevant for the present situation in which the motor vehicle is situated. If, for example, a motor vehicle is presently driving, a malfunction in the engine control may result in a violation of the safety objective “unintended acceleration.” In contrast, the safety objective “unintended movement from a standstill” cannot be violated in this case. It may therefore be provided to carry out a monitoring function in this situation, which verifies whether or not unintended acceleration is present, and to carry out a monitoring function, which verifies whether or not an “unintended movement from a standstill” is present.

In this case, it may be provided that a discrete state, in which the motor vehicle currently is situated, is ascertained with the aid of a state machine, monitoring functions being carried out or not as a function of the ascertained discrete state. This has the particular advantage that this safety concept may be particularly easily refined. It is particularly easily applicable, since the state machine is variant-independent and, for example, may be configured based merely on possible driving situations, i.e., largely independent of a configuration of the motor vehicle.

According to one refinement of this aspect, it may be provided that monitoring models are activated as a function of the ascertained discrete state, a monitoring function associated with the respective monitoring model being carried out for active monitoring models. It may be provided that these monitoring models ascertain actual variables and/or setpoint variables of the motor vehicle and communicate them to the respectively associated monitoring functions. Such a method is particularly easily maintainable and refinable, since the monitoring models are modularly integrated into the concept and are thus easily replaceable.

It is, in particular, also possible that a plurality of monitoring models is activated with respect to the same ascertained discrete state. Since each monitoring model is configured to discover a particular subsetpoint of potential error patterns, i.e., has merely a limited effectiveness, it is possible to achieve a high error coverage with such a combination. For example, it is possible to combine a monitoring model, which is provided essentially for static operations such as, for example, driving at a constant speed, with another monitoring model, which is provided essentially for dynamic operations such as, for example, driving with acceleration in the longitudinal direction. In this way, the monitoring models may be more easily configured and a high error coverage may be achieved for the driving situations to be considered.

Finally, it is possible to use impermissible or implausible or physically impossible conditions of the motor vehicle for monitoring, by the associated monitoring functions indicating errors when it is detected that the ascertained discrete state is impermissible or implausible or physically impossible. Such a monitoring may be carried out, for example, by designing a monitoring model as a discrete monitoring model, which verifies that this verification of the ascertained discrete state is carried out.

For example, the presence of an error may then be indicated if a high internal engine torque (i.e., an internal engine torque greater than a predefinable threshold value) of an internal combustion engine of the motor vehicle is detected, and at the same time there is neither a torque requested by a driver of the motor vehicle nor a torque requested by auxiliary units or consumers.

According to another aspect, it may be provided that when a monitoring function ascertains an error, an error response function associated with this monitoring function is carried out in order to return the motor vehicle to a safe state.

Moreover, it is also possible in this case to provide that monitoring functions are invoked only if they are applicable in the ascertained discrete state. For example, it is possible for thrust monitoring to function only if the driver does not actuate the accelerator pedal. In such a case, the state machine is advantageously configured in such a way that it differentiates between the states “accelerator pedal actuated” and “accelerator pedal not actuated.” The thrust monitoring is then advantageously invoked only if the ascertained discrete state corresponds to the condition “accelerator pedal not actuated.” If the thrust monitoring corresponds to the condition “accelerator pedal actuated,” torque monitoring is then invoked, for example.

It is also possible for the state machine to receive information about a position of the motor vehicle, for example, via a navigation device and/or via a GPS system and/or via a digital map, and the ascertained discrete state is determined based on this information. In this case, it is possible, for example, to cover cases in which monitoring functions at specific locations do not function reliably. For example, it is possible that acceleration monitoring does not function reliably in the case of a draft of wind in a tunnel. If the state machine includes states, which take into account the position information “in the tunnel” or “outside the tunnel” in the ascertained discrete state, the acceleration monitoring may be reliably deactivated and an alternative monitoring activated instead. As a result, the reliability of the system is increased.

In other aspects, the present invention relates to a computer program configured to carry out all steps of one of the methods according to one of the aforementioned aspects, an electronic storage medium on which the computer program is stored, and a control unit configured to carry out all steps of one of the methods according to one of the aforementioned aspects.

The figures show, by way of example, particularly advantageous specific embodiments of the present invention.

### BRIEF DESCRIPTION OF THE DRAWINGS

FIG. 1 shows a structural diagram according to one first aspect of the present invention.

FIG. 2 shows a structural diagram according to one second aspect of the present invention.

FIG. 3 shows a flow chart of the possible progression of a specific embodiment of the present invention.

### DETAILED DESCRIPTION

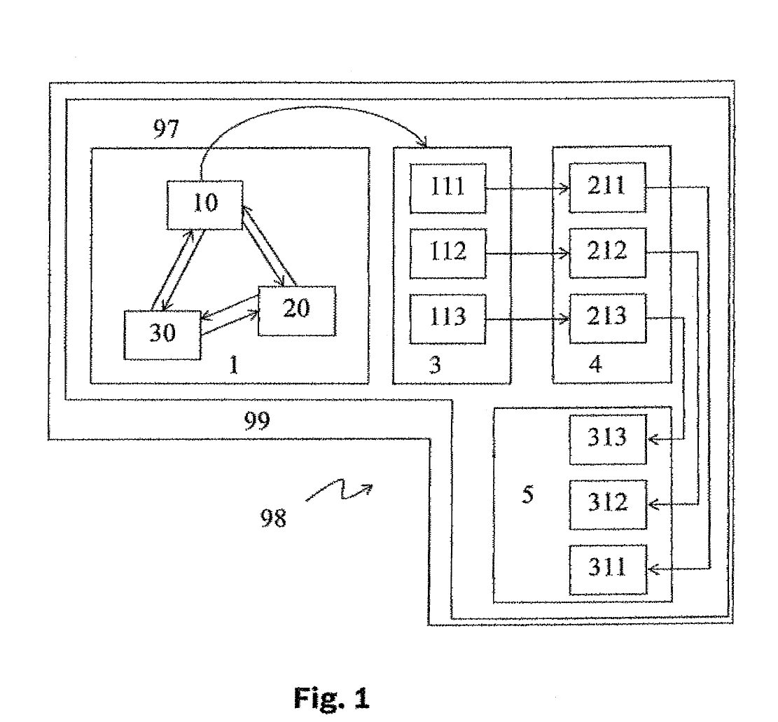

FIG. 1 shows a control unit 99, for example, an engine control unit, of a motor vehicle 98, on which the method according to the present invention may run. For example, the method is implemented in a computer program, which is stored on an electronic storage medium 97. For those skilled in the art, it is understood that the method according to the present invention may be implemented in software, or may be implemented in hardware, or may be implemented partly in software and partly in hardware.

The computer program includes a state machine 1, which ascertains discrete states 10, 20, 30, in which motor vehicle 98 is presently situated, for example, “motor vehicle driving,” “motor vehicle stopped,” etc. A monitoring unit 3 includes monitoring models 111, 112, 113. In each state of the motor vehicle, those monitoring models are invoked which monitor the violation of the safety objectives relevant for that state.

For example, in the state “motor vehicle driving,” identified by reference numeral 10, the monitoring models “unintended acceleration” (reference numeral: 111), “unintended yaw rate” (reference numeral: 112), and “unintended activation of parking brake” (reference numeral: 113) may be activated. Instead of these monitoring models, it is also possible to activate multiple partial models in each case. For example, instead of the monitoring model “unintended acceleration,” a monitoring model for driving at a constant speed and a monitoring model for an accelerating driving operation may be activated.

If no violation of a safety objective is possible in the ascertained discrete state, it is also possible that none of monitoring models 111, 112, 113 is activated.

Also provided is an error detection block 4. Each monitoring model 111, 112, 113 is associated with one or multiple monitoring functions 211, 212, 213 in error detection block 4 and, for example, each monitoring model 111, 112, 113 outputs a setpoint variable and/or an actual variable of a variable to be monitored, for example, of the torque of the internal combustion engine or of a longitudinal acceleration of motor vehicle 98. In this sense, it may be said that the monitoring model monitors this respective variable.

The setpoint variable the and actual variable are compared with one another in error detection block 4 and an error is detected as a function of this comparison. It is then possible for monitoring functions 211, 212, 213 implemented in code to appear identical and merely to receive different arguments.

However, it is also possible that in monitoring model 111, 112, 113, discrete states of motor vehicle 98 are detected as implausible or even physically impossible. It is possible that the monitoring models only carry out plausibility checks as a function of discrete states. If this should be insufficient for the requisite error coverage, monitoring models, which monitor continuous variables such as, for example, a torque, may be added in parallel hereto.

If an error is detected in error detection block 4, an error response function 311, 312, 313 associated with monitoring function 211, 212, 213 is invoked in an error response block 5. For example, if the monitoring function “unintended acceleration” 111 has indicated an error in error monitoring block 211, the speed of the internal combustion may be throttled in error response function 311.

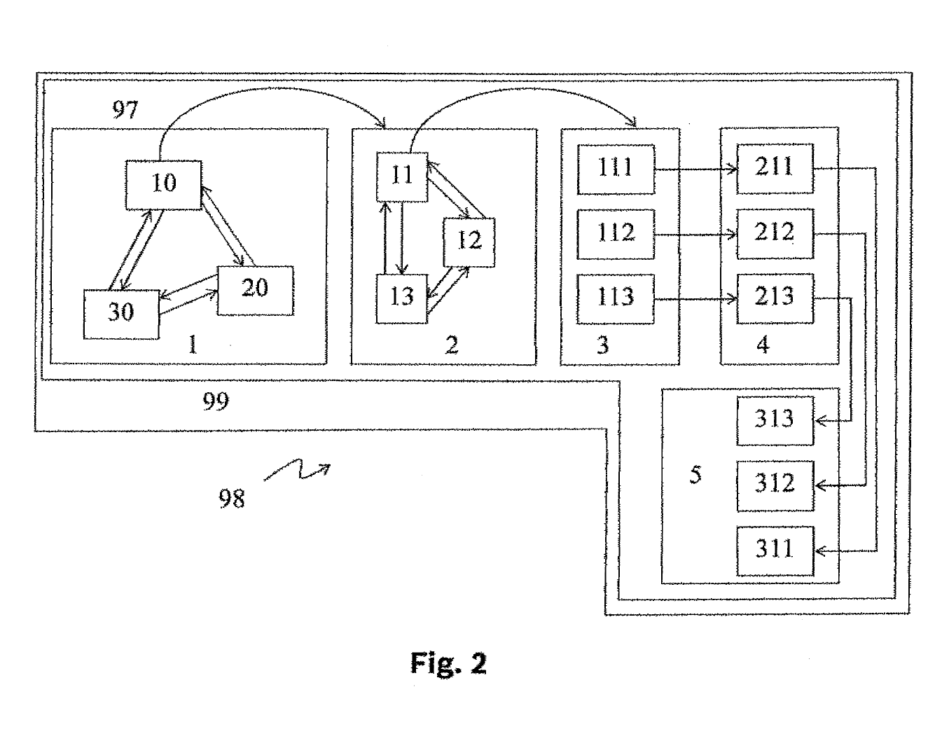

FIG. 2 shows another aspect of the present invention. Instead of a single state machine 1, a second state machine 2, which enables a more precise description of the present ascertained state 10, 20, 30 by present detail states 11, 12, 13, is provided as a function of present ascertained state 10, 20, 30 of state machine 1. For example, it may be provided that state machine 1 includes basic states of motor vehicle 98 such as, for example, “drive” or “stop.” If it is ascertained that the basic state is “drive,” another state machine is branched to, in which, for example, driving situations are differentiated, for example, “straight ahead,” “negotiate the curve,” “drive in reverse”, etc. Which of these driving situations is present may be ascertained based on information available in motor vehicle 98, for example, based on the steering angle or the instantaneous torque of the internal combustion engine, but also based on external information such as, for example, a GPS positioning. Monitoring functions 111, 112, 113 are activated according to this aspect based on the detected driving situation.

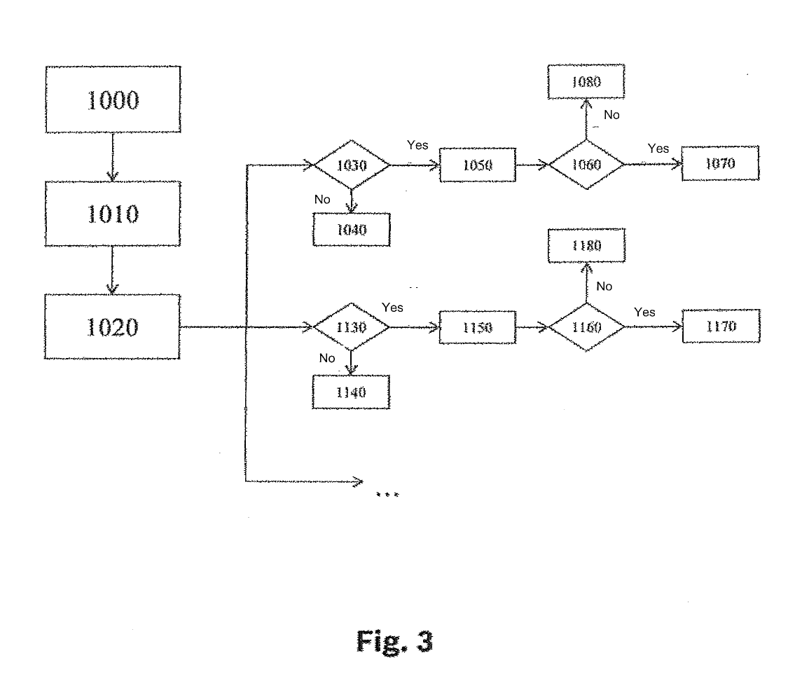

FIG. 3 shows a flow chart of a possible progression of a third aspect of the present invention, as it is implemented as software, for example, in control unit 99.

In step 1000, a present actual state 10 of motor vehicle 98 is ascertained in state machine 1. In subsequent state 1010, second state machine 2 is selected as a function of actual state 10 of motor vehicle 98 and actual situation 11 of motor vehicle 98 is determined. In subsequent step 1020, it is determined which of monitoring models 111, 112, 113 available in monitoring block 3 is to be activated. This is followed by parallel branches 1030 through 1080, 1130 through 1180, etc., for example, a branch for each available monitoring model 111, 112, 113. In step 1030 and 1130, it is verified whether the respective model of monitoring model 111, 112, 113 associated with the branch is activated. If this is not the case, the respective branch ends with steps 1040 and 1140. Otherwise, steps 1050 and 1150 follow, in which the actual variable and setpoint variable associated with the respective monitoring model 111, 112, 113 are determined and conveyed to the respective error detection model 211, 212, 213 of error detection block 4. In steps 1060 and 1160 it is then verified whether an absolute value of a difference between the actual variable and that of the setpoint variable exceeds a respectively predefinable tolerance value. If this is not the case, it is indicated in the respective branch in steps 1080 and 1180 that no error is detected by monitoring model 111, 112, 113 associated with the respective branch. Otherwise, errors of the variable of the associated monitoring model 111, 112, 113 to be monitored are indicated, and in steps 1070 and 1170, the countermeasure defined by corresponding error response function 311, 312, 313 is carried out in error response block 5.

What is claimed is:

1. A method for determining whether an error condition is present in a motor vehicle, the method comprising:
ascertaining a discrete state in which the motor vehicle is currently situated with the aid of a state machine; and
performing monitoring functions for ascertaining whether an error condition is present as a function of the ascertained discrete state.

2. The method of claim 1, wherein monitoring models are activated as a function of the ascertained discrete state, a monitoring function associated with the respective monitoring model being performed for active ones of the monitoring models.

3. The method of claim 2, wherein when a monitoring function ascertains an error, an error response function associated with this monitoring function is performed.

4. The method of claim 1, wherein actual variables, which describe an instantaneous state of the motor vehicle and/or setpoint variables, which describe an intended state of the motor vehicle, are communicated to the monitoring functions.

5. The method of claim 1, wherein monitoring models are activated as a function of the ascertained discrete state, a monitoring function associated with the respective monitoring model being performed for active ones of the monitoring models, wherein actual variables, which describe an instantaneous state of the motor vehicle and/or setpoint variables, which describe an intended state of the motor vehicle, are communicated to the monitoring functions, and wherein the actual variables and/or the setpoint variables are ascertained by a monitoring model.

6. The method of claim 1, wherein information about a spatial position of the motor vehicle is incorporated in the ascertained discrete state.

7. The method of claim 1, wherein the monitoring functions also include discrete monitoring functions, which decide whether an error condition is present or not, depending on the ascertained discrete state of the motor vehicle.

8. A computer readable medium having a computer program, which is executable by a processor, comprising:
a program code arrangement having program code for determining whether an error condition is present in a motor vehicle, by performing the following:
ascertaining a discrete state in which the motor vehicle is currently situated with the aid of a state machine; and
performing monitoring functions for ascertaining whether an error condition is present as a function of the ascertained discrete state.

9. The computer readable medium of claim 8, wherein monitoring models are activated as a function of the ascertained discrete state, a monitoring function associated with the respective monitoring model being performed for active ones of the monitoring models.

10. A control unit for determining whether an error condition is present in a motor vehicle, comprising:
a control arrangement configured to ascertain a discrete state in which the motor vehicle is currently situated with the aid of a state machine, and to perform monitoring functions for ascertaining whether an error condition is present as a function of the ascertained discrete state.
